(19) United States
(12) Patent Application Publication
(10) Pub. No.: US 2026/0051292 A1
(43) Pub. Date: Feb. 19, 2026

(54) PIXEL, DISPLAY DEVICE INCLUDING THE PIXEL, AND ELECTRONIC APPRATUS INCLUDING THE PIXEL

(71) Applicant: Samsung Display Co., Ltd., Yongin-Si (KR)

(72) Inventors: Daehyun Kim, Yongin-si (KR); Minki Yang, Yongin-si (KR); CHANGKYU JIN, Yongin-si (KR)

(21) Appl. No.: 19/281,764

(22) Filed: Jul. 28, 2025

(30) Foreign Application Priority Data
Aug. 13, 2024 (KR) 10-2024-0108062

(51) Int. Cl. G09G 3/3233; G09G 3/3266

(52) U.S. Cl. CPC G09G 3/3233; G09G 3/3266; G09G 2300/0819; G09G 2300/0852; G09G 2300/0861; G09G 2310/08

(57) ABSTRACT

A pixel includes a first transistor connected between a first power voltage terminal and a first node and turned on and off by a first light-emission control signal, a driving transistor connected in series with the first transistor and a light-emitting element and turned on and off by a signal applied to a gate terminal of the driving transistor, a second transistor connected between a data line and a second node connected to the gate terminal of the driving transistor, and turned on and off by a scan signal, a first capacitor connected between the first power voltage terminal and the first node, and a second capacitor connected between the first node and the second node.

### CROSS-REFERENCE TO RELATED APPLICATION

This application is based on and claims priority under 35 USC § 119 to Korean Patent Application No. 10-2024-0108062 filed on Aug. 13, 2024 in the Korean Intellectual Property Office, the disclosure of which is incorporated by reference herein in its entirety.

### BACKGROUND

### 1. Field

One or more embodiments relate to a pixel and a display device including the same.

### 2. Description of the Related Art

A pixel emits light based on a data voltage and includes a transistor (e.g., a thin-film transistor (TFT)) that controls the driving of the pixel. A display device may display images in a sequential emission method in which pixels emit light sequentially in rows, or in a simultaneous emission method in which all pixels emit light simultaneously after data write is completed sequentially.

### SUMMARY

One or more embodiments include a pixel and a display device including the pixel. The problems to be solved by the disclosure are not limited to the problems mentioned above, and other problems and advantages of the disclosure that are not mentioned may be understood by the following description and will be more clearly understood by the embodiments of the disclosure. In addition, it will be appreciated that the problems and advantages to be solved by the disclosure may be realized by the means and combinations thereof indicated in the claims.

Additional aspects will be set forth in part in the description which follows and, in part, will be apparent from the description, or may be learned by practice of the presented embodiments of the disclosure.

According to one or more embodiments, a pixel includes a first transistor connected between a first power voltage terminal and a first node and turned on and off by a first light-emission control signal, a driving transistor connected in series with the first transistor and a light-emitting element and turned on and off by a signal applied to a gate terminal of the driving transistor, a second transistor connected between a data line and a second node connected to the gate terminal of the driving transistor, and turned on and off by a scan signal, a first capacitor connected between the first power voltage terminal and the first node, and a second capacitor connected between the first node and the second node.

In an embodiment, the pixel may further include a third transistor connected to the second node and a node between the driving transistor and the light-emitting element, and a fourth transistor connected between the second node and an initialization voltage terminal and turned on and off by an initialization scan signal.

In an embodiment, the third transistor may be turned on and off by the initialization scan signal or a compensation scan signal.

In an embodiment, the pixel may further include a fifth transistor connected between the first node and the driving transistor and turned on and off by a second light-emission control signal.

In an embodiment, the pixel may further include a sixth transistor connected to an anode initialization voltage terminal and a node between the driving transistor and the light-emitting element, and turned on and off by a bypass scan signal, and a seventh transistor connected to an on-bias voltage terminal and the first node, and turned on and off by the bypass scan signal.

In an embodiment, in a first period, the third transistor and the fourth transistor may be turned on, an initialization voltage may be supplied to the second node from the initialization voltage terminal, and a voltage obtained by adding a threshold voltage of the driving transistor to the initialization voltage may be applied to the first node.

In an embodiment, in a second period, the second transistor may be turned on, a data voltage may be supplied to the second node, and a voltage proportional to an amount of change in a voltage of the second node may be additionally applied to the first node.

In one embodiment, in a third section, the first transistor may be turned on, a first power voltage may be supplied to the first node, and a voltage according to an amount of change in a voltage of the first node may be additionally applied to the second node.

According to one or more embodiments, a display device includes a display unit including a plurality of pixels, wherein each of the plurality of pixels is connected to a corresponding scan line among a plurality of scan lines, a corresponding light-emission control line among a plurality of light-emission control lines, and a corresponding data line among a plurality of data lines, a scan driver configured to supplying a scan signal corresponding to each of the plurality of pixels through the plurality of scan lines, a light-emission control driver configured to supply a light-emission control signal corresponding to each of the plurality of pixels through the plurality of light-emission control lines, a data driver configured to supply a data voltage corresponding to each of the plurality of pixels through the plurality of data lines, and a power supply unit configured to supply a first power voltage to each of the plurality of pixels, wherein each of the plurality of pixels includes a first transistor connected between a first power voltage terminal and a first node, and turned on and off by a first light-emission control signal included in the light-emission control signals, a driving transistor connected in series with the first transistor and a light-emitting element and turned on and off by a signal applied to a gate terminal of the driving transistor, a second transistor connected between the data line and a second node connected to the gate terminal of the driving transistor, and turned on and off by the scan signal, a first capacitor connected between the first power voltage terminal and the first node, and a second capacitor connected between the first node and the second node.

In an embodiment, the power supply unit may be configured to supply an initialization voltage to each of the plurality of pixels, the scan driver may be configured to supply an initialization scan signal to each of the plurality of pixels, and each of the plurality of pixels may further include a third transistor connected to the second node and a node between the driving transistor and the light-emitting element, and a fourth transistor connected between the second node and an initialization voltage terminal and turned on and off by an initialization scan signal.

In an embodiment, the scan driver may be further configured to supply a compensation scan signal to each of the plurality of pixels, and the third transistor may be turned on and off by the initialization scan signal or the compensation scan signal.

In an embodiment, the light-emission control signal may include a second light-emission control signal, and each of the plurality of pixels may further include a fifth transistor connected between the first node and the driving transistor and turned on and off by the second light-emission control signal.

In an embodiment, the power supply unit may be further configured to supply an anode initialization voltage and an on-bias voltage to each of the plurality of pixels, the scan driver may be further configured to supply a bypass scan signal to each of the plurality of pixels, and each of the plurality of pixels may further include a sixth transistor connected to an anode initialization voltage terminal and a node between the driving transistor and the light-emitting element, and turned on and off by the bypass scan signal, and a seventh transistor connected to an on-bias voltage terminal and the first node, and turned on and off by the bypass scan signal.

In an embodiment, in a first period, the third transistor and the fourth transistor may be turned on, the initialization voltage may be supplied to the second node, and a voltage obtained by adding a threshold voltage of the driving transistor to the initialization voltage may be applied to the first node.

In an embodiment, in a second period, the second transistor may be turned on, the data voltage may be supplied to the second node, and a voltage proportional to an amount of change in a voltage of the second node may be additionally applied to the first node.

In an embodiment, in a third period, the first transistor may be turned on, the first power voltage may be supplied to the first node, and a voltage according to an amount of change in a voltage of the first node may be additionally applied to the second node.

In an embodiment, an electronic apparatus includes a display device that displays an image and a processor that controls the display device. The display device includes a plurality of pixels wherein each of the plurality of pixels is connected to a respective scan line among a plurality of scan lines, a respective light-emission control line among a plurality of light-emission control lines, and a respective data line among a plurality of data lines, wherein each of the plurality of pixels comprises: a first transistor connected between a first power voltage terminal and a first node, and turned on and off by a first light-emission control signal included in the light-emission control signals; a driving transistor connected in series with the first transistor and a light-emitting element and turned on and off by a signal applied to a gate terminal of the driving transistor; a second transistor connected between the data line and a second node connected to the gate terminal of the driving transistor, and turned on and off by the scan signal; a first capacitor connected between the first power voltage terminal and the first node; and a second capacitor connected between the first node and the second node.

In the electronic apparatus, each of the plurality of pixels may further include a third transistor connected to the second node and a node between the driving transistor and the light-emitting element; and a fourth transistor connected between the second node and an initialization voltage terminal and turned on and off by an initialization scan signal.

In the electronic apparatus, each of the plurality of pixels may further include a fifth transistor connected between the first node and the driving transistor and turned on and off by a second light-emission control signal.

In the electronic apparatus, each of the plurality of pixels may further include a sixth transistor connected to an anode initialization voltage terminal and a node between the driving transistor and the light-emitting element, and turned on and off by a bypass scan signal generated by a scan driver; and a seventh transistor connected to an on-bias voltage terminal and the first node, and turned on and off by the bypass scan signal.

Other aspects, features, and advantages other than those described above will now become apparent from the following drawings, claims, and the detailed description of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a display device according to an embodiment;

FIG. 2 is a circuit diagram showing the structure of a pixel in the related art;

FIG. 3 is a circuit diagram showing the structure of a pixel according to an embodiment;

FIG. 4 is a timing diagram of signals for driving the pixel of FIG. 3;

FIG. 5 is a circuit diagram for describing an operation of elements of the pixel of FIG. 3 in an initialization section;

FIG. 6 is a circuit diagram for describing an operation of the elements of the pixel of FIG. 3 in a data write section;

FIG. 7 is a circuit diagram for describing an operation of the elements of the pixel of FIG. 3 in an anode initialization section;

FIG. 8 is a circuit diagram for describing an operation of the elements of the pixel of FIG. 3 in a light-emitting section;

FIG. 9 is a circuit diagram showing the structure of a pixel according to another embodiment;

FIG. 10 is a circuit diagram showing the structure of a pixel according to another embodiment;

FIG. 11 is a circuit diagram showing the structure of a pixel according to another embodiment;

FIG. 12 is a timing diagram of signals for driving the pixel of FIG. 11;

FIG. 13 is a circuit diagram showing the structure of a pixel according to another embodiment;

FIG. 14 is a timing diagram of signals for driving the pixel of FIG. 13;

FIG. 15 is a circuit diagram showing the structure of a pixel according to another embodiment; and

FIG. 16 is a timing diagram of signals for driving the pixel of FIG. 15.

FIG. 17 is a block diagram showing an electronic apparatus according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As the disclosure allows for various changes and numerous embodiments, particular embodiments will be illustrated in the drawings and described in detail in the written description. Effects and features of the disclosure and methods of achieving the same will be apparent with reference to embodiments and drawings described below in detail. The disclosure may, however, be embodied in many different forms and should not be construed as being limited to the embodiments set forth herein.

In the following embodiments, while such terms as “first,” “second,” etc., may be used to describe various elements, such elements must not be limited to the above terms.

In the following embodiments, an expression used in the singular encompasses the expression of the plural, unless it has a clearly different meaning in the context.

In the following embodiments, it is to be understood that the terms such as “including” and “having” are intended to indicate the existence of the features, or elements disclosed in the disclosure, and are not intended to preclude the possibility that one or more other features or elements may exist or may be added.

It will be understood that when a unit, region, or element is referred to as being formed on another unit, region, or element, it can be directly or indirectly formed on the other unit, region, or element. That is, for example, intervening units, regions, or elements may be present.

In the following embodiments, terms such as “connect” or “couple” do not necessarily mean a direct and/or fixed connection or coupling of two members, unless the context clearly indicates otherwise, and do not exclude the case where another member is interposed between the two members.

Sizes of elements in the drawings may be exaggerated for convenience of explanation. In other words, since sizes and thicknesses of components in the drawings are arbitrarily illustrated for convenience of explanation, the following embodiments are not limited thereto.

The disclosure will now be described more fully with reference to the accompanying drawings, in which preferred embodiments of the disclosure are shown. Like reference numerals in the drawings denote like elements, and thus their description will not be repeated.

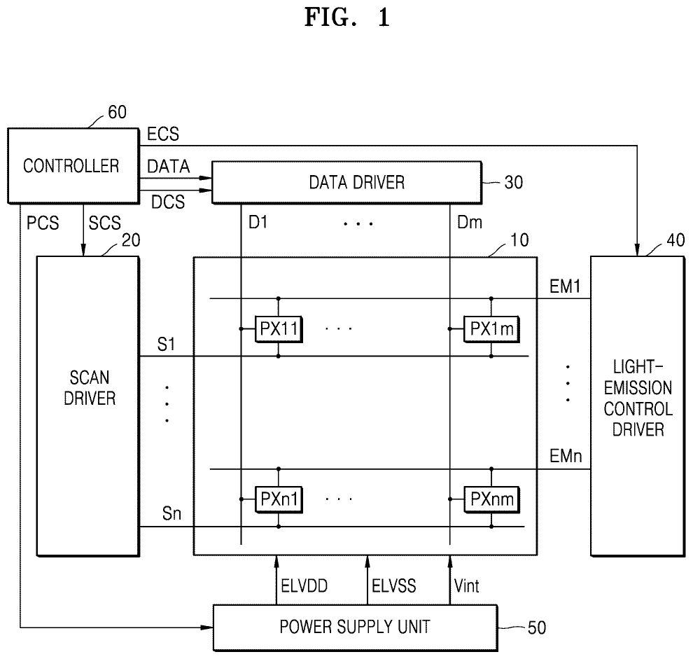

FIG. 1 is a block diagram illustrating a display device according to an embodiment.

Referring to FIG. 1, a display device according to an embodiment may include a display unit 10 including a plurality of pixels PX11 to PXnm, a scan driver 20, a data driver 30, a light-emission control driver 40, a power supply unit 50, and a controller 60.

In an embodiment, each of the plurality of pixels PX11 to PXnm may be connected to a corresponding one or more scan lines among a plurality of scan lines S1 to Sn, a corresponding one or more light-emission control lines among a plurality of light-emission control lines EM1 to EMn, and a corresponding one or more data lines among a plurality of data lines D1 to Dm, wherein the scan lines, the light-emission control lines, and the data lines are connected to the display unit 10.

In an embodiment, although not directly shown in the display unit 10 of FIG. 1, each of the plurality of pixels PX11 to PXnm may be connected to a power supply line connected to the display unit 10 to receive power for operations of the pixels, such as a first power voltage ELVDD, a second power voltage ELVSS, and an initialization voltage Vint.

In an embodiment, the display unit 10 may include the plurality of pixels PX11 to PXnm, which are arranged in a certain shape, for example, in a matrix shape.

In an embodiment, each of the plurality of pixels PX11 to PXnm may emit light having a certain brightness by a driving current supplied to a light-emitting element according to a corresponding data voltage transmitted through the plurality of data lines D1 to Dm.

The display unit 10 may be referred to as a display panel. In the disclosure, the display panel may be implemented as one of a liquid crystal display (LCD), a light-emitting diode (LED) display, an organic LED (OLED) display, an active-matrix OLED (AMOLED) display, an electrochromic display (ECD), a digital mirror device (DMD), an actuated mirror device (AMD), a grating light valve (GLV), a plasma display panel (PDP), an electro-luminescent display (ELD), a vacuum fluorescent display (VFD), and may also be implemented as other types of flat-panel displays or flexible displays.

In an embodiment, the scan driver 20 may generate and transmit a scan signal corresponding to each pixel through the plurality of scan lines S1 to Sn. That is, the scan driver 20 may transmit a scan signal through a scan line corresponding to each of the plurality of pixels included in each row. For example, the scan driver 20 may receive a scan driving control signal SCS from the controller 60 to generate a plurality of scan signals, and may sequentially supply the generated scan signals to the plurality of scan lines S1 to Sn connected to each row.

Although not shown in FIG. 1, in an embodiment, the scan driver 20 may generate and supply one or more types of scan signals. As a particular example, the scan driver 20 may generate and supply scan signals required depending on an implementation or emission control method of the pixel, such as a first scan signal GW (not shown), a second scan signal GI (or an initialization scan signal) (not shown), a third scan signal GB (or bypass scan signal) (not shown), and a fourth scan signal GC (a compensation scan signal) (not shown). Accordingly, the plurality of scan lines S1 to Sn may include one or more types of scan lines, so that a scan line may be configured for each scan signal. In particular, the first scan signal GW may be applied to each of the plurality of pixels PX11 to PXnm through a plurality of first scan lines GWL1 to GWLn (not shown), the second scan signal GI may be applied to each of the plurality of pixels PX11 to PXnm through a plurality of second scan lines GIL1 to GILn (not shown), the third scan signal GB may be applied to each of the plurality of pixels PX11 to PXnm through a plurality of third scan lines GBL1 to GBLn (not shown), and the fourth scan signal GC may be applied to each of the plurality of pixels PX11 to PXnm through a plurality of fourth scan lines GCL1 to GCLn (not shown).

In an embodiment, the data driver 30 may transmit a data signal to each pixel through the plurality of data lines D1 to Dm. For example, the data driver 30 may receive a data driving control signal DCS from the controller 60 and supply data signals corresponding to the plurality of data lines D1 to Dm respectively connected to the plurality of pixels PX11 to PXnm included in each row.

In an embodiment, the light-emission control driver 40 may be connected to the plurality of light-emission control lines EM1 to EMn connected to the display unit 10 including the plurality of pixels PX11 to PXnm arranged in a matrix shape. That is, the plurality of light-emission control lines EM1 to EMn extending in a row direction of each of the plurality of pixels and being almost parallel to each other may connect each of the plurality of pixels and the light-emission control driver 40 to each other.

In an embodiment, the light-emission control driver 40 may generate and transmit a light-emission control signal corresponding to each pixel through the plurality of light-emission control lines EM1 to EMn. Each pixel that receives a light-emission control signal may be controlled to emit an image according to an image data signal in response to the control by the light-emission control signal. That is, an operation of a light-emission control transistor included in each pixel may be controlled in response to the light-emission control signal transmitted through a corresponding light-emission control line, and accordingly, a light-emitting element connected to the light-emission control transistor may or may not emit light at a brightness according to a driving current corresponding to a data signal.

In an embodiment, two light-emission control signals may be supplied to each pixel. That is, the emission of one pixel may be controlled based on two types of light-emission control signals.

In an embodiment, the power supply unit 50 may supply the first power voltage ELVDD, the second power voltage ELVSS, the initialization voltage Vint, an anode initialization voltage VAINT, an on-bias voltage VOBS, or the like to each pixel of the display unit 10. For example, the first power voltage ELVDD may be a certain high-level voltage, and the second power voltage ELVSS may be a voltage lower than the first power voltage ELVDD or a ground voltage. For example, the initialization voltage Vint may be set to a voltage value that is equal to or lower than the second power voltage ELVSS.

The voltage values of the first power voltage ELVDD, the second power voltage ELVSS, and the initialization voltage Vint are not particularly limited, but the voltage values may be set or controlled according to a power control signal PCS transmitted from the controller 60.

In an embodiment, the controller 60 may convert a plurality of image signals transmitted from the outside into a plurality of image data signals DATA and transmit the same to the data driver 30. In addition, the controller 60 may receive a vertical synchronization signal Vsync (not shown), a horizontal synchronization signal Hsync (not shown), and a clock signal MCLK (not shown), and may generate and transmit control signals for controlling the driving of the scan driver 20, the light-emission control driver 40, and the data driver 30, respectively. That is, the controller 60 may generate and transmit a scan driving control signal SCS that controls the scan driver 20, a light-emission driving control signal ECS that controls an operation of the light-emission control driver 40, and the data driving control signal DCS that controls the data driver 30. In addition, the controller 60 may generate the power control signal PCS that controls an operation of the power supply unit 50 and transmit the generated power control signal PCS to the power supply unit 50.

In an embodiment, the display device may further include a reference voltage generator (not shown). For example, the reference voltage generator may generate a reference voltage VRef based on a control signal received from the controller 60. The reference voltage generator may provide the reference voltage VRef to the data driver 30. The reference voltage VRef may have a value corresponding to each data signal DATA. The reference voltage generator may be arranged within the controller 60 or within the data driver 30.

In an embodiment, the data driver 30 may receive the data driving control signal DCS from the controller 60 and may receive the reference voltage VRef from the reference voltage generator. The data driver 30 may convert the data signal DATA into a data voltage VDATA in an analog form by using the reference voltage VRef. For example, the data driver 30 may output the data voltage VDATA to a data line.

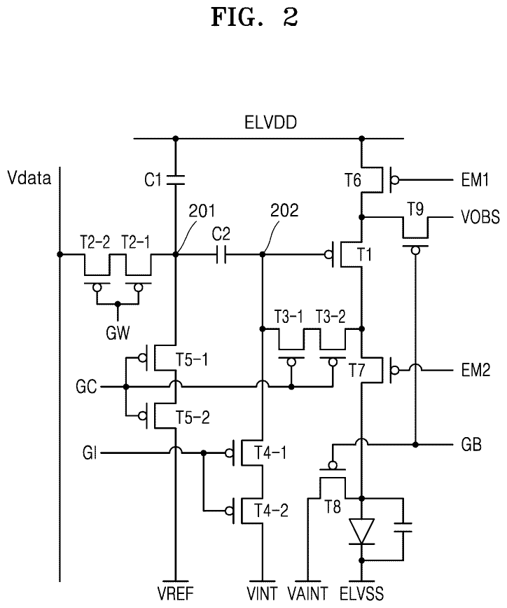

FIG. 2 is a circuit diagram showing the structure of a pixel in the related art.

Referring to FIG. 2, a pixel may include a light-emitting element and a pixel circuit for controlling emission or non-emission of the light-emitting element. The pixel circuit illustrated in FIG. 2 may include nine transistors (i.e., first to ninth transistors T1 to T9) and two capacitors (i.e., first and second capacitors C1 and C2).

Referring to FIG. 2, the first capacitor C1 and the second capacitor C2 may be arranged between a gate terminal of the first transistor T1 and a terminal of the first power voltage ELVDD. The first capacitor C1 may be a storage capacitor that serves to store a data voltage of a pixel, and the second capacitor C2 may be a holding capacitor that helps maintain the data and stabilizes the pixel until the data switches to data for the next frame.

When looking at the terminal of the first power voltage ELVDD from the gate terminal of the first transistor T1, the first capacitor C1 and the second capacitor C2 are connected in series, specifically, the first capacitor C1 is arranged between the terminal of the first power voltage ELVDD and a first node 201, and the second capacitor C2 is arranged between the first node 201 and a second node 202. As a result, because two capacitors connected in series are arranged between the gate terminal of the first transistor T1 and the terminal of the first power voltage ELVDD, an adverse effect may occur on the driving characteristics.

To overcome the above-described problems, pixels (or pixel circuits) according to various embodiments are described below.

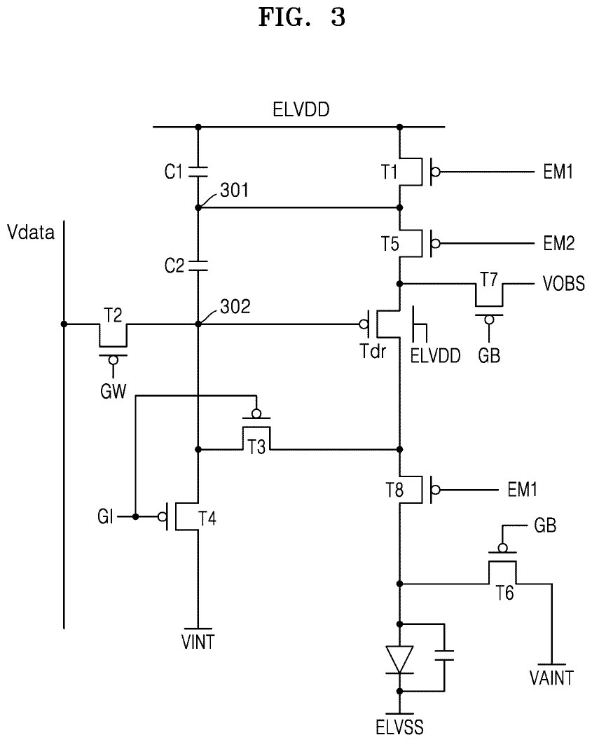

FIG. 3 is a circuit diagram showing the structure of a pixel according to an embodiment.

Referring to FIG. 3, a pixel according to an embodiment may include nine transistors (i.e., driving transistor Tdr plus first to eighth transistors T1 to T8) and two capacitors (i.e., first and second capacitors C1 and C2).

Referring to FIG. 3, a driving transistor Tdr is shown that is turned on and off by a signal applied to a gate terminal thereof and configured to control a current for emission of a light-emitting element. In an embodiment, the gate terminal of the driving transistor Tdr may be connected to a drain terminal of the second transistor T2. The second transistor T2 may be connected to a data line that is configured to supply a data voltage Vdata to the pixel. A source terminal of the second transistor T2 may be connected to a data line. The second transistor T2 may be turned on and off by the first scan signal GW to control the supply of data voltage Vdata.

Referring to FIG. 3, in an embodiment, the first transistor T1 and the fifth transistor T5 may be connected in series with the driving transistor Tdr. In particular, a drain terminal of the fifth transistor T5 may be connected to a source terminal of the driving transistor Tdr, a drain terminal of the first transistor T1 may be connected to a source terminal of the fifth transistor T5, and the first power voltage ELVDD may be supplied to a source terminal of the first transistor T1. The first transistor T1 may be turned on and off by a first light-emission control signal EM1, and the fifth transistor T5 may be turned on and off by a second light-emission control signal EM2.

Referring to FIG. 3, a pixel according to an embodiment may include a first capacitor C1 having a first end connected to a terminal of the first power voltage ELVDD and a second end connected to the source terminal of the fifth transistor T5, and the second capacitor C2 having a first end connected to the source terminal of the fifth transistor T5 and a second end connected to a gate terminal of the driving transistor Tdr.

Referring to FIG. 3, in an embodiment, the third transistor T3 that is turned on and off by the second scan signal GI and the fourth transistor T4 that is turned on and off by the second scan signal GI may be connected to the gate terminal of the driving transistor Tdr. In particular, a source terminal of the third transistor T3 may be connected to the gate terminal of the driving transistor Tdr. In particular, a drain terminal of the fourth transistor T4 may be connected to the gate terminal of the driving transistor Tdr. The initialization voltage VINT may be supplied to a source terminal of the fourth transistor T4.

Referring to FIG. 3, in an embodiment, the eighth transistor T8 that is turned on and off by the first light-emission control signal EM1 may be connected to the driving transistor Tdr. In particular, a source terminal of the eighth transistor T8 may be connected to the drain terminal of the driving transistor Tdr. In addition, the eighth transistor T8 may be connected to the third transistor T3. In particular, the source terminal of the eighth transistor T8 may be connected to the drain terminal of the third transistor T3.

Referring to FIG. 3, in an embodiment, the sixth transistor T6 that is turned on and off by the third scan signal GB may be connected to the eighth transistor T8. In particular, a drain terminal of the sixth transistor T6 may be connected to a drain terminal of the eighth transistor T8. The anode initialization voltage VAINT may be supplied to a source terminal of the sixth transistor T6.

Referring to FIG. 3, in an embodiment, the light-emitting element may be connected to the eighth transistor T8 and the sixth transistor T6. In particular, an anode of the light-emitting element may be connected to the drain terminal of the eighth transistor T8 and the drain terminal of the sixth transistor T6. A cathode of the light-emitting element may be connected to a terminal of the second power voltage ELVSS.

Referring to FIG. 3, in an embodiment, the seventh transistor T7 that is turned on and off by the third scan signal GB may be connected to the driving transistor Tdr. In particular, a drain terminal of the seventh transistor T7 may be connected to the source terminal of the driving transistor Tdr. The on-bias voltage VOBS may be supplied to a source terminal of the seventh transistor T7.

Unlike the pixel of FIG. 2, a first node 301 between the first capacitor C1 and the second capacitor C2 of the pixel according to an embodiment illustrated in FIG. 3 may be connected to the drain terminal of a first transistor T1 that is turned on and off by the first light-emission control signal EM1 and configured to supply the first power voltage ELVDD, and a second node 302 between the second capacitor C2 and the gate terminal of the driving transistor Tdr may be connected to the drain terminal of the second transistor T2 that is turned on and off by the first scan signal GW and configured to supply the data voltage Vdata.

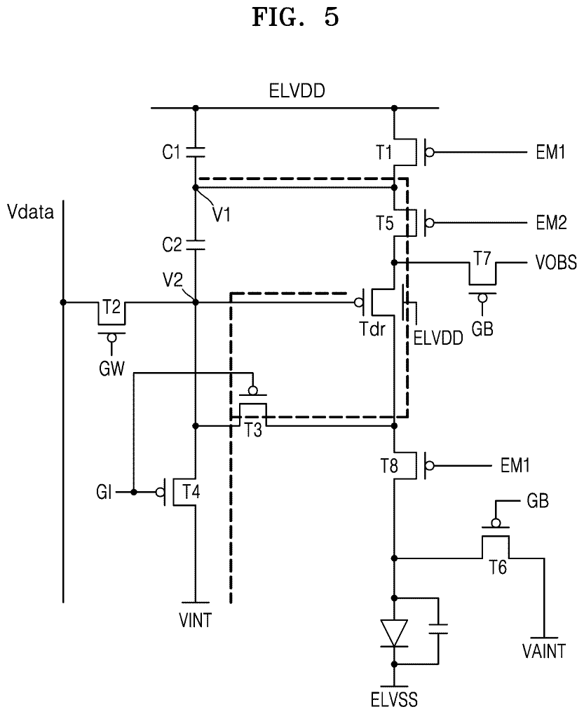

Advantages or effects of the pixel according to an embodiment illustrated in FIG. 3 may become more apparent from the description of particular operations to be made with reference to FIGS. 5 to 8.

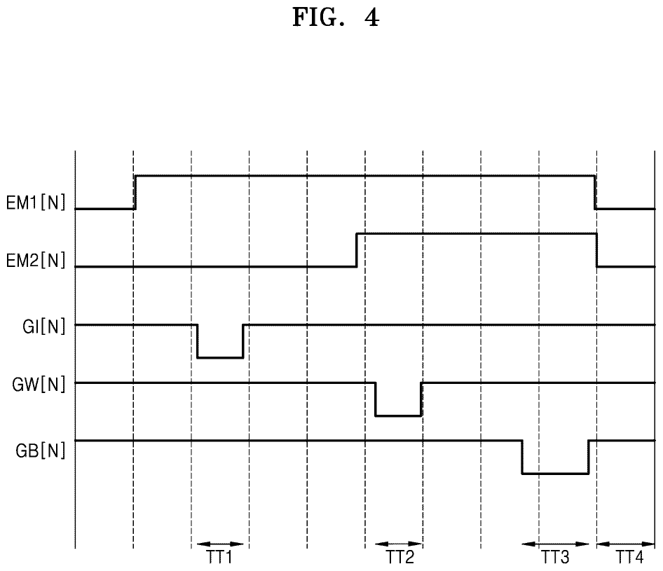

FIG. 4 is a timing diagram of signals for driving the pixel of FIG. 3.

Referring to FIG. 4, changes in the signals applied to the pixel of FIG. 3 (i.e., the first light-emission control signal EM1, the second light-emission control signal EM2, the first scan signal GW, the second scan signal GI, and the third scan signal GB) during one unit period (e.g., a single frame period) are illustrated.

Referring to FIG. 4, one unit period may largely include an initialization period TT1, a data write period TT2, an anode initialization period TT3, and an emission period TT4. The initialization period TT1 may be a period in which the initialization voltage VINT is applied to initialize the gate terminal of a driving transistor of the pixel. The data write period TT2 may be a period in which the data voltage Vdata is applied to the gate terminal of the driving transistor of the pixel. The anode initialization period TT3 may be a period in which the anode initialization voltage VAINT is applied to the anode of the light-emitting element. In addition, the anode initialization period TT3 may be a period in which the on-bias voltage VOBS is applied to the source terminal of the driving transistor of the pixel. The emission period TT4 may be a period in which a flowing current of the pixel is applied to the light-emitting element by the driving transistor to allow the light-emitting element to emit light or not emit light.

Hereinafter, referring to FIGS. 5 to 8, an operation of each period of a pixel according to an embodiment illustrated in FIG. 3 is described. In FIGS. 5 to 8, periods that are electrically connected and where signals are transmitted and received are indicated by dotted lines.

FIG. 5 is a circuit diagram for describing an operation of the elements of the pixel of FIG. 3 in an initialization period.

Referring to the values of signals in the initialization period TT1 of FIG. 4, it is shown that the second scan signal GI applied to the gate terminal of the third transistor T3 and the gate terminal of the fourth transistor T4 of FIG. 3, and the second light-emission control signal EM2 applied to the gate terminal of the fifth transistor T5 have low voltages. Accordingly, the third transistor T3, the fourth transistor T4, and the fifth transistor T5 may be turned on.

Referring to FIG. 5, the fourth transistor T4 may be turned on, so that the initialization voltage VINT supplied to the source terminal of the fourth transistor T4 may be applied to the gate terminal of the driving transistor Tdr. Accordingly, a second voltage V2 applied to the second node 302 of FIG. 3 may be VINT. As the initialization voltage VINT is applied to the gate terminal of the driving transistor Tdr, the driving transistor Tdr may also be turned on.

Referring to FIG. 5, the third transistor T3 is turned on, so that the initialization voltage VINT supplied to the source terminal of the third transistor T3 may be supplied to the drain terminal of the driving transistor Tdr. The driving transistor Tdr is turned on, and a value of a voltage of the drain terminal of the driving transistor Tdr is VINT, and thus a value of a voltage of the source terminal of the driving transistor Tdr may be VINT+Vth when a threshold voltage of the driving transistor Tdr is Vth. Accordingly, a first voltage V1 applied to the first node 301 of FIG. 3 may be VINT+Vth.

In summary, after the initialization period TT1, the first voltage V1 may be VINT+Vth, and the second voltage V2 may be VINT. Accordingly, a voltage stored in the second capacitor C2 may be Vth.

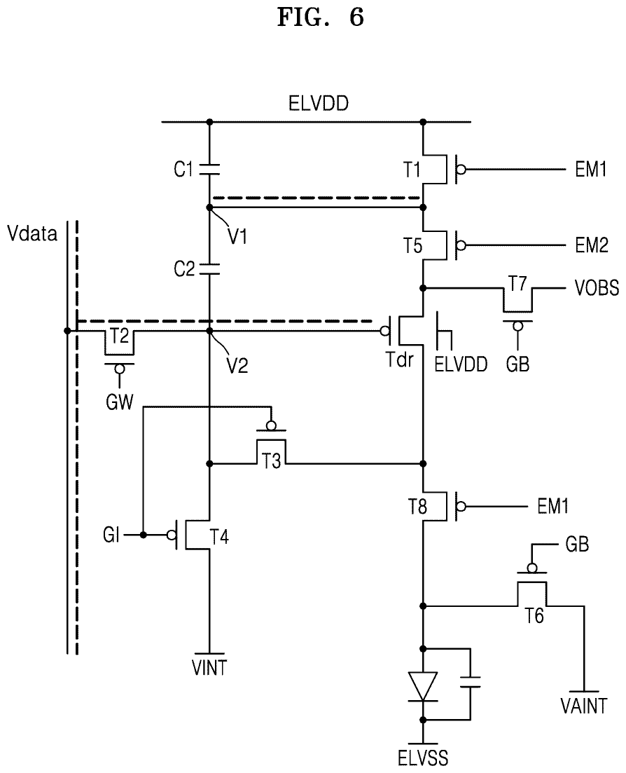

FIG. 6 is a circuit diagram for describing an operation of the elements of the pixel of FIG. 3 in a data write period.

Referring to the values of signals in the data write period TT2 of FIG. 4, it is shown that the first scan signal GW applied to the gate terminal of the second transistor T2 has a low voltage. Accordingly, the second transistor T2 may be turned on.

Referring to FIG. 6, the second transistor T2 is turned on, so that the data voltage Vdata may be applied to the gate terminal of the driving transistor Tdr. Accordingly, the second voltage V2 may be Vdata.

As the second voltage V2 changes from VINT to Vdata, a voltage proportional to an amount of change in the second voltage V2 (i.e., Vdata−VINT) may be additionally applied to the first voltage V1. In particular, the first voltage V1 may vary by (Vdata−VINT)*(C2/(C1+C2)). Here, C2/(C1+C2) may be understood as being generated by the first capacitor C1 and the second capacitor C2, which are interpreted as being connected in series.

Therefore, after the data write period TT2, the first voltage V1 may be VINT+Vth+(Vdata−VINT)*(C2/(C1+C2)), and the second voltage V2 may be Vdata.

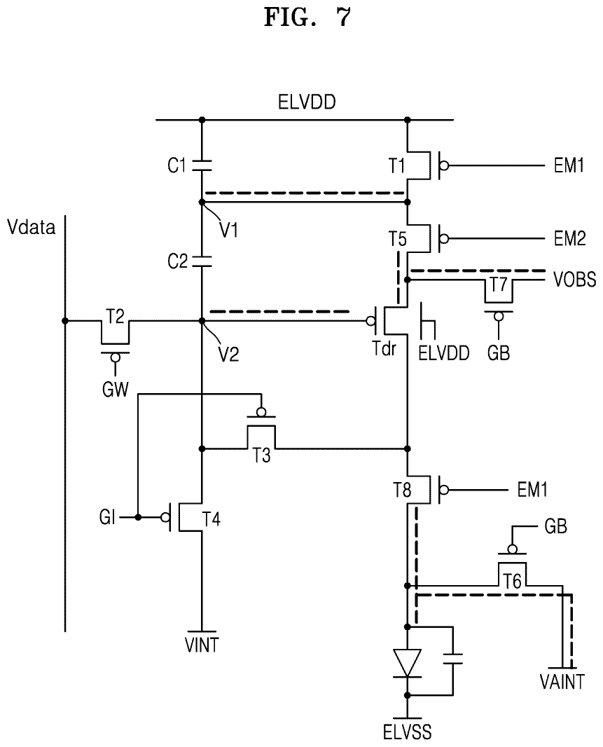

FIG. 7 is a circuit diagram for describing an operation of elements of the pixel of FIG. 3 in an anode initialization period.

Referring to the values of signals in the anode initialization period TT3 of FIG. 4, it is shown that the third scan signal GB applied to the gate terminal of the sixth transistor T6 and the seventh transistor T7 has a low voltage. Accordingly, the sixth transistor T6 and the seventh transistor T7 may be turned on.

Referring to FIG. 7, the sixth transistor T6 is turned on, so that the anode initialization voltage VAINT may be applied to the anode of the light-emitting element.

Referring to FIG. 7, the seventh transistor T7 is turned on, so that the on-bias voltage VOBS may be applied to the source terminal of the driving transistor Tdr.

In summary, after the anode initialization period TT3, the first voltage V1 may be VINT+Vth+(Vdata−VINT)*(C2/(C1+C2)), and the second voltage V2 may be Vdata. That is, both the first voltage V1 and the second voltage V2 after the data write period TT2 are maintained even after the anode initialization period TT3 has passed.

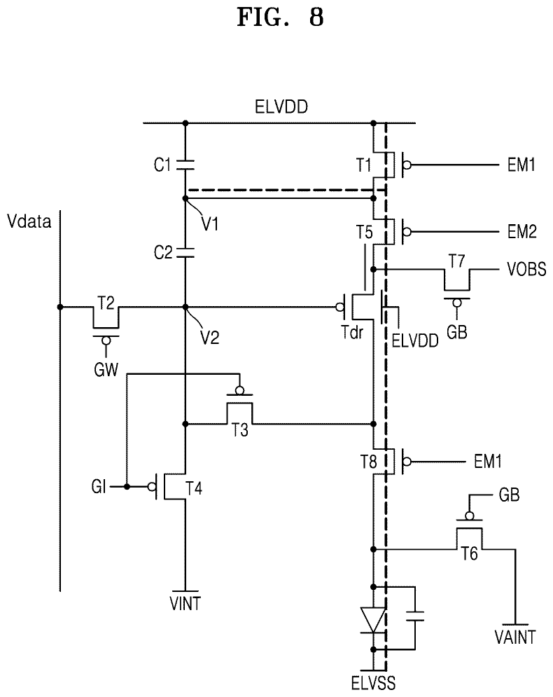

FIG. 8 is a circuit diagram for describing an operation of the elements of the pixel of FIG. 3 in an emission section.

Referring to the values of signals in the emission period TT4 of FIG. 4, it is shown that the first light-emission control signal EM1 applied to the gate terminal of the first transistor T1 and the gate terminal of the eighth transistor T8 and the second light-emission control signal EM2 applied to the gate terminal of the fifth transistor T5 have low voltages. Accordingly, the first transistor T1 and the fifth transistor T5 may be turned on.

Referring to FIG. 8, as the first transistor T1 is turned on, the first voltage V1 may become equal to the first power voltage ELVDD. That is, in emission period TT4, the first node 301 of FIG. 3 acts as the first power voltage ELVDD, and thus the first node 301 may not be interpreted as an individual node on the circuit.

As the first voltage V1 changes from VINT+Vth+(Vdata−VINT)*(C2/(C1+C2)) to ELVDD, a voltage according to a change amount of the first voltage V1 (i.e., ELVDD−(VINT+Vth+(Vdata−VINT)*(C2/(C1+C2)))) may be additionally applied to the second voltage V2.

Therefore, to summarize, in the emission period TT4, the first voltage V1 may be ELVDD, and the second voltage V2 may be Vdata+ELVDD−(VINT+Vth+(Vdata−VINT)*(C2/(C1+C2))).

Referring to FIG. 8, as the fifth transistor T5 is turned on, the first power voltage ELVDD may be applied to the source terminal of the driving transistor Tdr.

Referring to FIG. 8, as the eighth transistor T8 is turned on, a current generated by the driving transistor Tdr may be supplied to the light-emitting element, and the light-emitting element may emit light or not emit light.

A size of a driving current I_{d} depending on voltage sizes of the terminals of the driving transistor Tdr may be calculated by the following Formula 1.

$${I}_{d} = \frac{1}{2} \times μ \times A \times {( {V}_{sg} - {V}_{th} )}^{2} \qquad [ Formula 1 ]$$

As described above, in the emission section, Vs is ELVDD, which is the first voltage V1, and Vg is Vdata+ELVDD−(VINT+Vth+(Vdata−VINT)*(C2/(C1+C2)), which is the second voltage V2, so Vsg and (Vsg−Vth)² may be calculated as in the following Formula 2.

$${V}_{sg} = ELVDD - ( Vdata + ELVDD - ( VINT + {V}_{th} + ( Vdata - VINT ) \times \frac{C 2}{C 1 + C 2} ) ) \qquad [ Formula 2 ]$$

$$\begin{matrix}{( Vsg - {V}_{th} )}^{2} = ( ( ELVDD - ( Vdata + ELVDD - ( VINT + {V}_{th} + \\ {( Vdata - VINT ) \times \frac{C 2}{C 1 + C 2} ) ) - {V}_{th} )}^{2} \\ = ( ELVDD - Vdata - ELVDD + VINT + {V}_{th} + \\ {( Vdata - VINT ) \times \frac{C 2}{C 1 + C 2} - {V}_{th} )}^{2} \\ = {( - Vdata + VINT + ( {v}_{data} - {v}_{INT} ) \times \frac{C 2}{C 1 + C 2} )}^{2}\end{matrix}$$

That is, according to Formula 2, in a process of calculating (Vsg−Vth)² in the pixel according to an embodiment, Vth is eliminated, so that Vth compensation may be performed.

As described above, according to the pixel according to an embodiment, as the first voltage V1 becomes the first power voltage ELVDD, the gate terminal of the driving transistor Tdr is directly connected to the terminal of the first power voltage ELVDD, which is a direct current (DC) power, through one capacitor (i.e., the second capacitor C2), and thus factors that may affect the gate terminal of the driving transistor Tdr are reduced, and accordingly, the gate terminal of the driving transistor Tdr may be designed to be robust.

Hereinafter, various embodiments based on the pixel according to the embodiment of FIG. 3 are described.

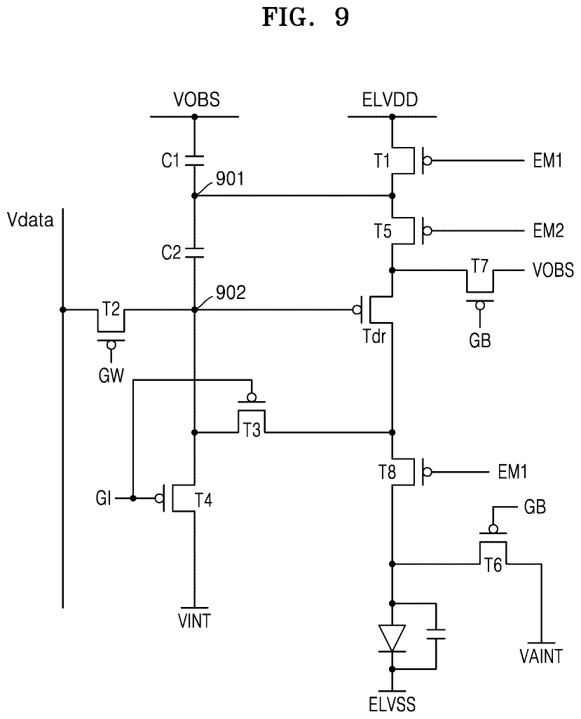

FIG. 9 is a circuit diagram showing the structure of a pixel according to another embodiment.

A first node 901 and a second node 902 of FIG. 9 may correspond to the first node 301 and the second node 302 of FIG. 3.

While the first node 301 of the pixel shown in FIG. 3 in the emission period is connected to the terminal of the first power voltage ELVDD, in various embodiments, the first node 301 may be designed to be connected to another DC power.

Referring to FIG. 9, a difference between the pixel according to the embodiment of FIG. 9 and the pixel according to the embodiment of FIG. 3 is that the first end of the first capacitor C1 is connected to a terminal of the on-bias voltage VOBS instead of the terminal of the first power voltage ELVDD.

In particular, in the pixel according to the embodiment of FIG. 9, the first end of the first capacitor C1 may be connected to the terminal of the on-bias voltage VOBS, and the second end of the first capacitor C1 may be connected to the drain terminal of the first transistor T1 and the source terminal of the fifth transistor T5 as the first node 901. Similar to the pixel according to the embodiment of FIG. 3, the first end of the second capacitor C2 may be connected to the first node 901, and the second end of the second capacitor C2 may be connected to the gate terminal of the driving transistor Tdr, the drain terminal of the second transistor T2, the source terminal of the third transistor T3, and the drain terminal of the fourth transistor T4 as the second node 902.

In addition to the embodiment illustrated in FIG. 9, in the pixel of the disclosure, the first node 901 may be designed to be connected to DC terminals, such as a terminal of the initialization voltage VINT, a terminal of the anode initialization voltage VAINT, and a terminal of the reference voltage VREF, with the first capacitor C1 therebetween.

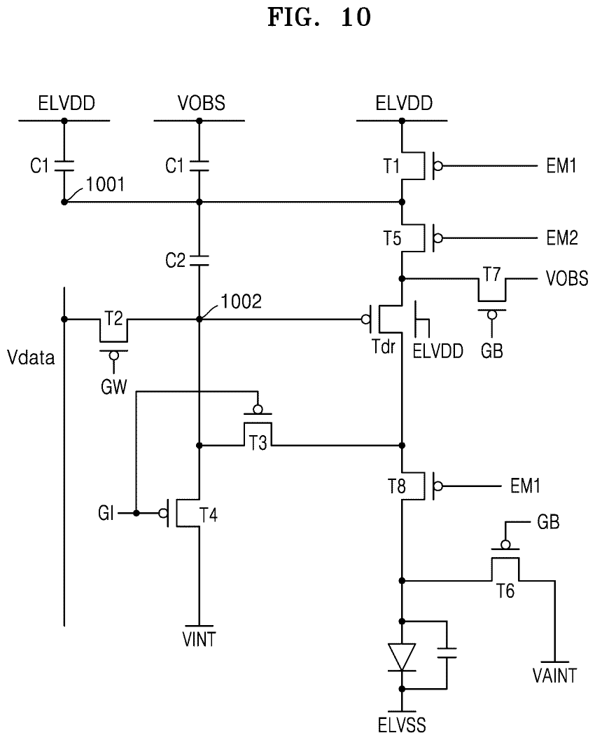

FIG. 10 is a circuit diagram showing the structure of a pixel according to another embodiment.

A first node 1001 and a second node 1002 of FIG. 10 may correspond to the first node 301 and the second node 302 of FIG. 3.

In an embodiment, the first node 1001 may be connected to different DC lines through a plurality of capacitors. In particular, referring to FIG. 10, the first node 1001 may be connected to both the first capacitor C1 having one terminal connected to the terminal of the first power voltage ELVDD and a third capacitor C3 having one terminal connected to the terminal of the on-bias voltage VOBS.

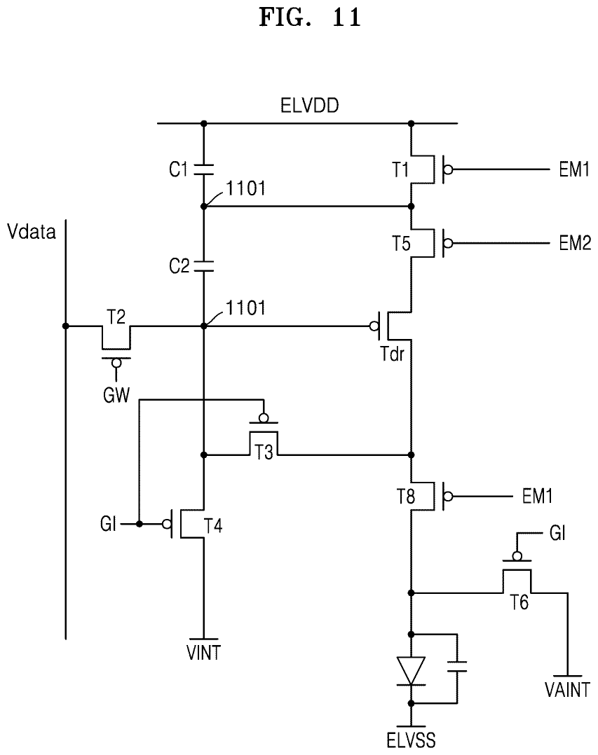

FIG. 11 is a circuit diagram showing the structure of a pixel according to another embodiment.

A first node 1101 and a second node 1102 of FIG. 11 may correspond to the first node 301 and the second node 302 of FIG. 3.

In an embodiment, a pixel may also be driven without the on-bias voltage VOBS and/or the third scan signal GB. Referring to FIG. 11, a transistor, such as a transistor that is turned on and off by the on-bias voltage VOBS (e.g., the seventh transistor T7 of FIG. 3) does not exist. In addition, the sixth transistor T6 of FIG. 3 is turned on and off by the third scan signal GB, while in the embodiment of FIG. 11, the sixth transistor T6 may be designed to be turned on and off by the second scan signal GI.

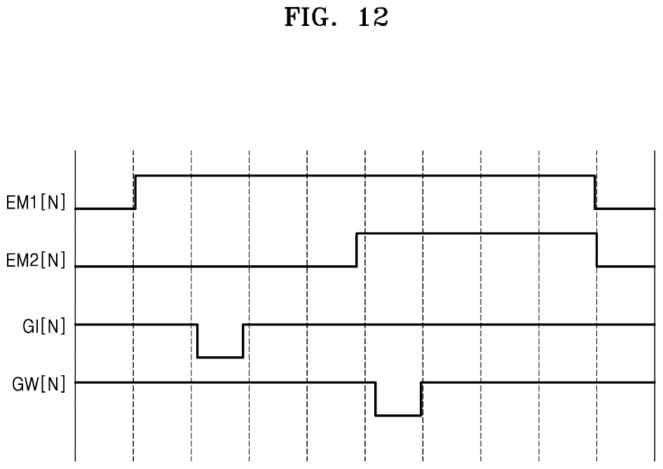

FIG. 12 is a timing diagram of signals for driving the pixel of FIG. 11.

Referring to FIG. 12, changes in the signals applied to the pixel of FIG. 11 (i.e., the first light-emission control signal EM1, the second light-emission control signal EM2, the first scan signal GW, and the second scan signal GI), during one unit period (e.g., a single frame period) are illustrated.

In the embodiment of FIG. 11, anode initialization of the light-emitting element may be controlled by the second scan signal GI because the third scan signal GB is not applied, and particularly, the anode initialization may be performed in a period in which the second scan signal GI has a low voltage in FIG. 12.

The remaining operations for this embodiment may be analogized to the operations described above with reference to FIGS. 3 to 8.

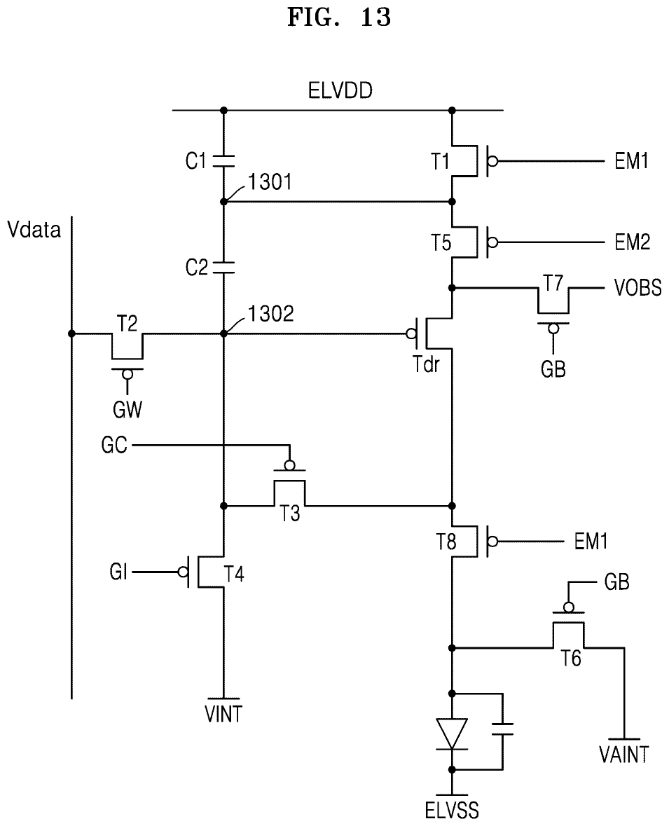

FIG. 13 is a circuit diagram showing the structure of a pixel according to another embodiment.

A first node 1301 and a second node 1302 of FIG. 13 may correspond to the first node 301 and the second node 302 of FIG. 3.

In an embodiment, the third transistor T3 may be turned on and off by the fourth scan signal GC, unlike the embodiment of FIG. 3 in which the third transistor T3 is turned on and off by the second scan signal GI.

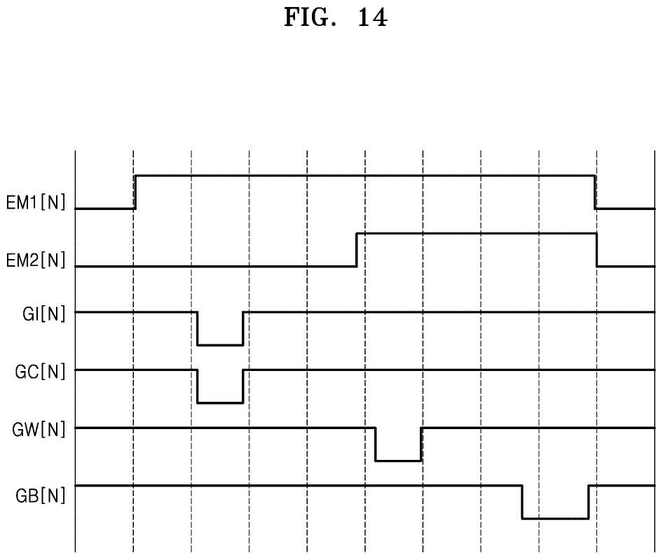

FIG. 14 is a timing diagram of signals for driving the pixel of FIG. 13.

Referring to FIG. 14, changes in the signals applied to the pixel of FIG. 13 (i.e., the first light-emission control signal EM1, the second light-emission control signal EM2, the first scan signal GW, the second scan signal GI, the third scan signal GB, and the fourth scan signal GC) during one unit period (e.g., a single frame period) are illustrated.

Referring to FIG. 14, except that the fourth scan signal GC exists in addition to the second scan signal GI, a period in which the fourth scan signal GC has a low voltage is also the same as a period in which the second scan signal GI has a low voltage, and thus the operation in FIG. 14 may be applied in the same manner as the operations described above with reference to FIGS. 3 to 8.

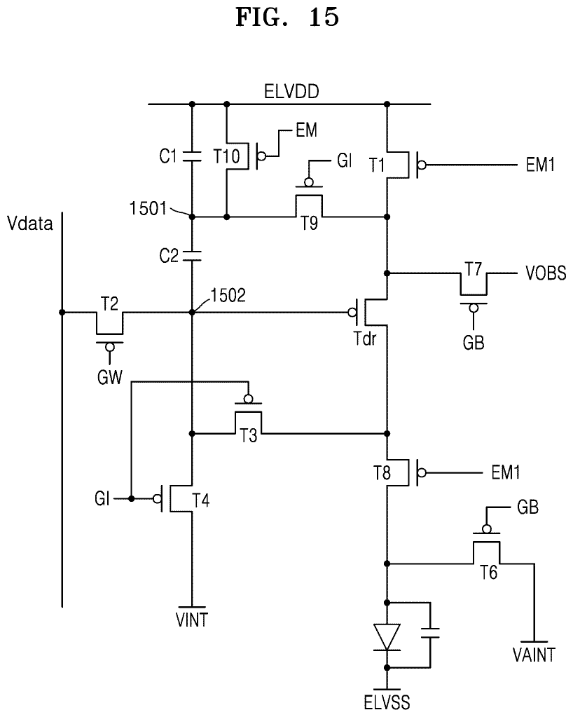

FIG. 15 is a circuit diagram showing the structure of a pixel according to another embodiment.

A first node 1501 and a second node 1502 of FIG. 15 may correspond to the first node 301 and the second node 302 of FIG. 3.

In an embodiment, the first light-emission control signal and the second light-emission control signal may be integrated. Unlike the pixel of FIG. 3 which includes the fifth transistor T5 that is turned on and off by the second light-emission control signal EM2, in the pixel according to the embodiment of FIG. 15, the second light-emission control signal EM2 is not applied and the transistor which is turned on and off by the second light-emission control signal (such as the fifth transistor T5 of FIG. 3) is not included.

In an embodiment, the pixel may include the first transistor T1 and a tenth transistor T10, which are turned on and off by an integrated light-emission control signal EM.

In an embodiment, the source terminal of the first transistor T1 may be connected to the terminal of the first power voltage ELVDD, and the drain terminal of the first transistor T1 may be connected to the source terminal of the driving transistor Tdr.

In an embodiment, a source terminal of the tenth transistor T10 may be connected to the terminal of the first power voltage ELVDD, and a drain terminal of the tenth transistor T10 may be connected to the first node 1501 between the first capacitor C1 and the second capacitor C2.

In an embodiment, the source terminal of the ninth transistor T9, which is turned on and off by the second scan signal GI, may be connected to the first node 1501, and the drain terminal of the ninth transistor T9 may be connected to the source terminal of the driving transistor Tdr.

With respect to the remaining transistors, the driving transistor Tdr, the second transistor T2, the third transistor T3, and the fourth transistor T4 of FIG. 15 may correspond to the driving transistor Tdr, the second transistor T2, the third transistor T3, and the fourth transistor T4 of FIG. 3, respectively. The eighth transistor T8, the sixth transistor T6, and the seventh transistor T7 of FIG. 15 may correspond to the eighth transistor T8, the sixth transistor T6, and the seventh transistor T7 of FIG. 3, respectively.

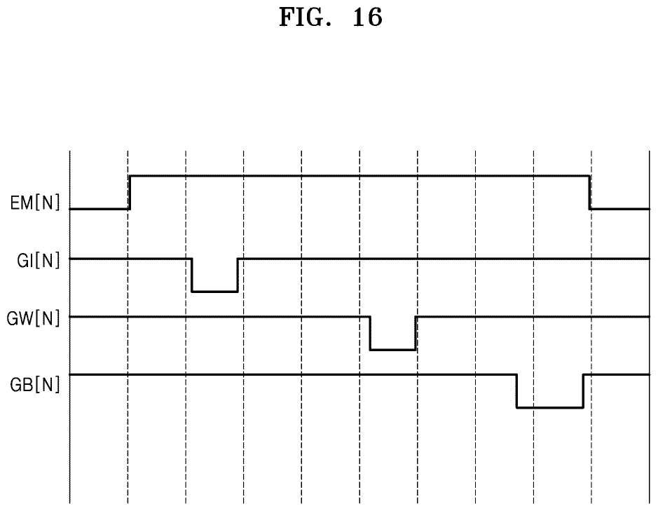

FIG. 16 is a timing diagram of signals for driving the pixel of FIG. 15.

Referring to FIG. 16, changes in the signals applied to the pixel of FIG. 15 (i.e., the first light-emission control signal EM1, the first scan signal GW, the second scan signal GI, and the third scan signal GB) during one unit period (e.g., a single frame period) are illustrated.

Referring to FIG. 16, there is a difference in which only the integrated light-emission control signal EM exists instead of the second light-emission control signal EM2. Apart from these differences, the operations described above with reference to FIGS. 3 to 8 may be similarly applied to the operations of the pixel within a single unit period.

Although each of the transistors included in the pixels according to the various embodiments has been described as being a single transistor as described above, each of the transistors included in the pixels according to the various embodiments may be a dual-gate transistor having two gate terminals. For example, the second transistor T2, the third transistor T3, and/or the fourth transistor T4 may be dual-gate transistors.

Each of the transistors included in the pixels according to the various embodiments as described above may be a four-terminal transistor.

Some of the transistors included in the pixels according to various embodiments as described above may be oxide transistors. For example, the second transistor T2 and the eighth transistor T8 may be transistors using an oxide semiconductor.

The pixels according to the various embodiments as described above may be designed so that the first node becomes a DC voltage (e.g., the first power voltage ELVDD) in the light-emission period, and the gate terminal of the driving transistor is connected to the DC voltage through only one capacitor without being affected by the series connection of the capacitors, thereby eliminating the risk of image quality characteristics while securing high-speed driving timing.

The transistors included in the pixels according to various embodiments as described above have been described based on P-type metal oxide semiconductor field effect transistors (MOSFET), but a design in which the transistors are changed to N-type MOSFETs is also included in various embodiments described in the disclosure, and such a design change will be easily understood by those skilled in the art.

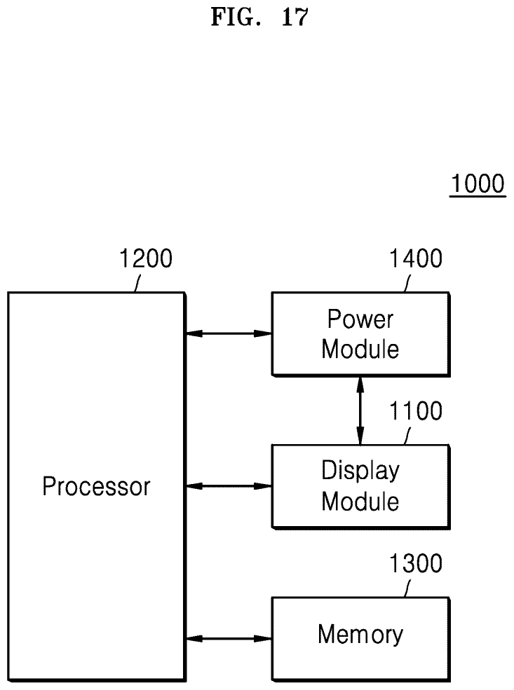

FIG. 17 depicts an electronic apparatus 1000 that includes a display module 1100, a processor 1200, a memory 1300, and a power module 1400. The electronic apparatus 1000 may further include a plurality of ports capable of communicating with a video card, a sound card, a memory card, a USB device, and the like, or communicating with other systems.

The processor 1200 may perform specific calculations or tasks. According to an embodiment, the processor 1200 may be a microprocessor, a central processing unit (CPU), or the like. The processor 1200 may be connected to other components through an address bus, a control bus, a data bus, and the like. According to an embodiment, the processor 1200 may also be connected to an expansion bus such as a peripheral component interconnect (PCI) bus. The processor 1200 may control the display module 1100.

The processor 1200 may control the display module 1100. In an embodiment, the processor 1200 may distribute the image data and the controller signal that are provided to the controller 140 of FIG. 1 to the display module 1100.

The memory 1300 may store data required for an operation of the electronic apparatus 1000. For example, the memory 1300 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

Each of the embodiments described above may be implemented independently, but the structure of each embodiment may be applied in combination to other embodiments.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

Specific implementations described in the embodiments are examples and do not limit the scope of the embodiments. In addition, if there is no specific mention such as “essential,” “important,” etc., it may not be a necessary component for the application of the disclosure.

The display device and the pixels disclosed herein may be used in various products such as portable electronic devices including mobile phones, smartphones, tablet personal computers (PCs), mobile communication terminals, electronic notebooks, e-books, portable multimedia players (PMPs), navigations, and ultra mobile PCs (UMPCs), and also televisions (TVs), laptops, monitors, billboards, Internet of Things (IoT), or the like. According to an embodiment, the display device and the pixels of this disclosure may also be used in wearable devices such as smart watches, watch phones, glasses-type displays, or head mounted displays (HMDs). According to an embodiment, the display device and pixels of this disclosure may also be used in dashboards of vehicles, center information displays (CIDs) of the center fascia or dashboards of vehicles, mirror displays that replace the side view mirrors of vehicles, and display screens arranged on the rear sides of front seats to serve as entertainment devices for back seat passengers of vehicles.

The use of the term “above” and similar referential terms in the specification of the embodiment (especially in the claims) may refer to both the singular and the plural. In addition, when a range is described in an embodiment, the disclosure includes the application of individual values within the range (unless there is a statement to the contrary), and is the same as describing each individual value constituting the range in the detailed description. Finally, unless the order of the operations constituting the method according to the embodiments is clearly stated or there is no description to the contrary, the operations may be performed in an appropriate order. The embodiments are not necessarily limited by the order of description of the operations above. The use of all examples or illustrative terms in the embodiments is simply for explaining the embodiments in detail, and the scope of the embodiments is not limited by the examples or illustrative terms unless limited by the claims. In addition, those skilled in the art will recognize that various modifications, combinations and changes may be made depending on design conditions and factors within the scope of the appended claims or their equivalents.

What is claimed is:

1. A pixel comprising:
a first transistor connected between a first power voltage terminal and a first node and turned on and off by a first light-emission control signal;
a driving transistor connected in series with the first transistor and a light-emitting element and turned on and off by a signal applied to a gate terminal of the driving transistor;
a second transistor connected between a data line and a second node connected to the gate terminal of the driving transistor, and turned on and off by a scan signal;
a first capacitor connected between the first power voltage terminal and the first node; and
a second capacitor connected between the first node and the second node.

2. The pixel of claim 1, further comprising:
a third transistor connected to the second node and a node between the driving transistor and the light-emitting element; and
a fourth transistor connected between the second node and an initialization voltage terminal and turned on and off by an initialization scan signal.

3. The pixel of claim 2, wherein the third transistor is turned on and off by the initialization scan signal or a compensation scan signal.

4. The pixel of claim 1, further comprising a fifth transistor connected between the first node and the driving transistor and turned on and off by a second light-emission control signal.

5. The pixel of claim 1, further comprising:
a sixth transistor connected to an anode initialization voltage terminal and a node between the driving transistor and the light-emitting element, and turned on and off by a bypass scan signal; and
a seventh transistor connected to an on-bias voltage terminal and the first node, and turned on and off by the bypass scan signal.

6. The pixel of claim 2, wherein, in a first period, the third transistor and the fourth transistor are turned on and thus an initialization voltage is supplied to the second node from the initialization voltage terminal, and a voltage obtained by adding a threshold voltage of the driving transistor to the initialization voltage is applied to the first node.

7. The pixel of claim 6, wherein, in a second period, the second transistor is turned on and thus a data voltage is supplied to the second node, and a voltage proportional to an amount of change in a voltage of the second node is additionally applied to the first node.

8. The pixel of claim 6, wherein, in a third period, the first transistor is turned on and thus a first power voltage is supplied to the first node, and a voltage according to an amount of change in a voltage of the first node is additionally applied to the second node.

9. A display device comprising:
a display unit comprising a plurality of pixels, wherein each of the plurality of pixels is connected to a respective scan line among a plurality of scan lines, a respective light-emission control line among a plurality of light-emission control lines, and a respective data line among a plurality of data lines;
a scan driver supplying a scan signal to each of the plurality of pixels through the plurality of scan lines;
a light-emission control driver supplying a light-emission control signal corresponding to each of the plurality of pixels through the plurality of light-emission control lines;
a data driver configured to supply a data voltage to each of the plurality of pixels through the plurality of data lines; and
a power supply unit configured to supply a first power voltage to each of the plurality of pixels,
wherein each of the plurality of pixels comprises:
a first transistor connected between a first power voltage terminal and a first node, and turned on and off by a first light-emission control signal included in the light-emission control signals;
a driving transistor connected in series with the first transistor and a light-emitting element and turned on and off by a signal applied to a gate terminal of the driving transistor;
a second transistor connected between the data line and a second node connected to the gate terminal of the driving transistor, and turned on and off by the scan signal;
a first capacitor connected between the first power voltage terminal and the first node; and
a second capacitor connected between the first node and the second node.

10. The display device of claim 9, wherein the power supply unit is configured to supply an initialization voltage to each of the plurality of pixels,
the scan driver is configured to supply an initialization scan signal to each of the plurality of pixels, and
each of the plurality of pixels further comprises:
a third transistor connected to the second node and a node between the driving transistor and the light-emitting element; and
a fourth transistor connected between the second node and an initialization voltage terminal and turned on and off by an initialization scan signal.

11. The display device of claim 10, wherein the scan driver is further configured to supply a compensation scan signal to each of the plurality of pixels, and
the third transistor is turned on and off by the initialization scan signal or the compensation scan signal.

12. The display device of claim 9, wherein the light-emission control signal comprises a second light-emission control signal, and
each of the plurality of pixels further comprises a fifth transistor connected between the first node and the driving transistor and turned on and off by the second light-emission control signal.

13. The display device of claim 9, wherein the power supply unit is further configured to supply an anode initialization voltage and an on-bias voltage to each of the plurality of pixels,
the scan driver is further configured to supply a bypass scan signal to each of the plurality of pixels, and
each of the plurality of pixels further comprises:
a sixth transistor connected to an anode initialization voltage terminal and a node between the driving transistor and the light-emitting element, and turned on and off by the bypass scan signal; and
a seventh transistor connected to an on-bias voltage terminal and the first node, and turned on and off by the bypass scan signal.

14. The display device of claim 10, wherein, in a first period, the third transistor and the fourth transistor are turned on and thus the initialization voltage is supplied to the second node, and a voltage obtained by adding a threshold voltage of the driving transistor to the initialization voltage is applied to the first node.

15. The display device of claim 14, wherein in a second period, the second transistor is turned on and thus the data voltage is supplied to the second node, and a voltage proportional to an amount of change in a voltage of the second node is additionally applied to the first node.

16. The display device of claim 14, wherein, in a third period, the first transistor is turned on and thus the first power voltage is supplied to the first node, and a voltage according to an amount of change in a voltage of the first node is additionally applied to the second node.

17. An electronic apparatus comprising:
a display device that displays an image; and
a processor that controls the display device,
wherein the display device comprises a plurality of pixels, wherein each of the plurality of pixels is connected to a respective scan line among a plurality of scan lines, a respective light-emission control line among a plurality of light-emission control lines, and a respective data line among a plurality of data lines, wherein each of the plurality of pixels comprises:
a first transistor connected between a first power voltage terminal and a first node, and turned on and off by a first light-emission control signal included in the light-emission control signals;
a driving transistor connected in series with the first transistor and a light-emitting element and turned on and off by a signal applied to a gate terminal of the driving transistor;
a second transistor connected between the data line and a second node connected to the gate terminal of the driving transistor, and turned on and off by the scan signal;
a first capacitor connected between the first power voltage terminal and the first node; and
a second capacitor connected between the first node and the second node.

18. The electronic apparatus of claim 17, wherein each of the plurality of pixels further comprises:
a third transistor connected to the second node and a node between the driving transistor and the light-emitting element; and
a fourth transistor connected between the second node and an initialization voltage terminal and turned on and off by an initialization scan signal.

19. The electronic apparatus of claim 17, wherein each of the plurality of pixels further comprises a fifth transistor connected between the first node and the driving transistor and turned on and off by a second light-emission control signal.

20. The electronic apparatus of claim 17, wherein each of the plurality of pixels further comprises:
a sixth transistor connected to an anode initialization voltage terminal and a node between the driving transistor and the light-emitting element, and turned on and off by a bypass scan signal generated by a scan driver; and
a seventh transistor connected to an on-bias voltage terminal and the first node, and turned on and off by the bypass scan signal.
